(19) United States
(12) Patent Application Publication
(10) Pub. No.: US 2004/0129124 A1
(43) Pub. Date: Jul. 8, 2004

(54) Punching device

(75) Inventor: Kwok Ki Chan, Hong Kong (HK)

Correspondence Address: LEYDIG VOIT & MAYER, LTD, 700 THIRTEENTH ST. NW, SUITE 300, WASHINGTON, DC, 20005-3960, US

(73) Assignee: Lee Tack Plastic & Metal Mfy., Ltd., Kwai Chung (HK)

(21) Appl. No.: 10/336,924

(22) Filed: Jan. 6, 2003

(51) Int. Cl. B26D 5/08; B26F 1/14

(52) U.S. Cl. 83/588; 83/613; 83/686

(57) ABSTRACT

A punching device for punching a hole in a sheet of material, comprising a metal body having an upper part and a lower part each having a front end and a rear end and an aperture between the two ends. The apertures have substantially identical shape and size and being horizontally aligned with each other. The upper and lower body parts are interconnected at their rear ends and vertically spaced apart to form a horizontal planar gap therebetween into which a said sheet may be inserted for punching. The punching device includes a punching die having a cross-section of a substantially identical shape and size as the apertures and supported within the upper aperture for downward movement across the gap into the lower aperture thereby punching a hole in a said sheet. A spacer is located in the gap for limiting undesirable downward movement of the upper body part relative to the lower body part during a punching action.

The present invention relates to a punching device for cutting a hole of a particular shape through a sheet of paper or plastic material, etc.

### BACKGROUND OF THE INVENTION

Paper punches for handicraft works are known, which are typically used to punch holes in a paper sheet for decoration or for any other purposes such as exposing part of a photograph to be placed underneath the punched paper sheet. For this or similar purpose, the hole usually needs to be relatively large, calling for the use of a jumbo-sized paper punch.

The kind of punching devices concerned typically include a metal body formed with upper and lower apertures separated by a horizontal planar gap. A punching die is slidable downwards from the upper aperture across the gap into the lower aperture for punching a hole in a paper sheet inserted into the gap. For practical reasons, the gap is difficult to be made as narrow as desired. This may give rise to the problem in that the upper body part may deform downwards during a punching action to such an extent that the punching die mis-aligns with and thus jammed by the lower aperture.

The invention seeks to mitigate or at least alleviate such a problem by providing an improved punching device of the type concerned.

### SUMMARY OF THE INVENTION

According to the invention, there is provided a punching device for punching a hole in a sheet of material, comprising a metal body having an upper part and a lower part each having a front end and a rear end and an aperture between the two ends. The apertures have substantially identical shape and size and being horizontally aligned with each other. The upper and lower body parts are interconnected at their rear ends and vertically spaced apart to form a horizontal planar gap therebetween into which a said sheet may be inserted for punching. The punching device includes a punching die having a cross-section of a substantially identical shape and size as the apertures and supported within the upper aperture for downward movement across the gap into the lower aperture thereby punching a hole in a said sheet. A spacer is located in the gap for limiting undesirable downward movement of the upper body part relative to the lower body part during a punching action.

Preferably, the spacer is located adjacent the front end of one of the upper and lower body parts, protruding into the gap for abutment with the other of the upper and lower body parts to limit said undesirable downward movement of the upper body part.

More preferably, the spacer is located at the front end of the upper body part, protruding downwards into the gap for abutment with the lower body part.

More specifically, the spacer has a C-shaped cross-section riding laterally on the front end of said one of the upper and lower body parts.

More specifically, the spacer comprises a clip embracing upper and lower sides of the front end of said one of the upper and lower body parts.

In a preferred embodiment, the gap has a certain vertical width, and the spacer has a vertical dimension of at least half of the gap width to limit said undesirable downward movement of the upper body part to within half of the gap width measured at the front ends of the body parts.

It is preferred that the gap has a substantially uniform vertical width exceeding 2.0 mm.

The punching device preferably includes a plurality of springs co-acting between the punching die and the upper body part to resiliently bias the punching die upwards, said springs being arranged to provide a balanced biassing force.

In a specific construction, the upper and lower body parts include and are enclosed by respective upper and lower plastic shells, said upper shell having a top aperture to enable depression of the punching die.

### BRIEF DESCRIPTION OF DRAWINGS

The invention will now be more particularly described, by way of example only, with reference to the accompanying drawings, in which:

FIG. 1 is a front perspective view of an embodiment of a punching device in accordance with the invention;

FIG. 2A is a side view of the punching device of FIG. 1 in a normal condition;

FIG. 2B is a side view corresponding to FIG. 2A, showing the punching device in a punching condition;

FIG. 3 is a cross-sectional side view corresponding in mirror image to FIG. 2A;

FIG. 4A is a top plan view of part of the punching device of FIG. 3, taken in direction IVA;

FIG. 4B is a bottom plan view of part of the punching device of FIG. 3, taken in direction IVB; and

FIGS. 5A to 5D are front, top plan, bottom plan and side views of a spacer of the punching device of FIG. 3.

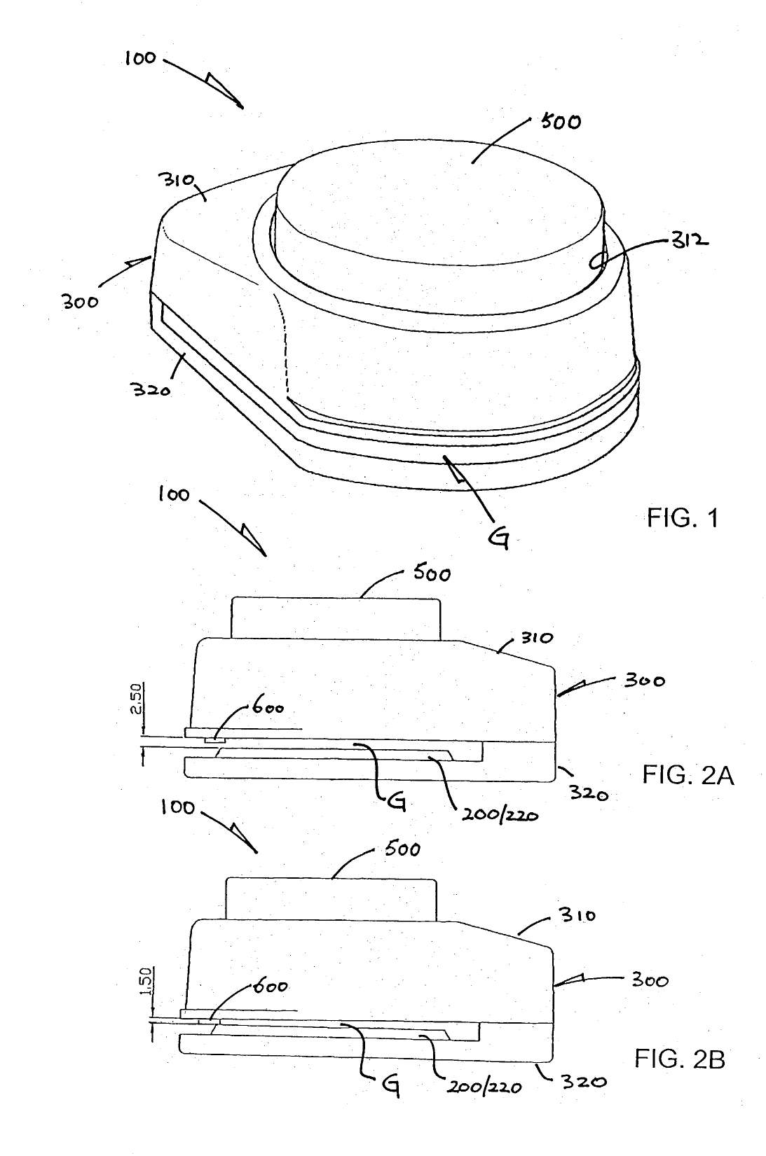

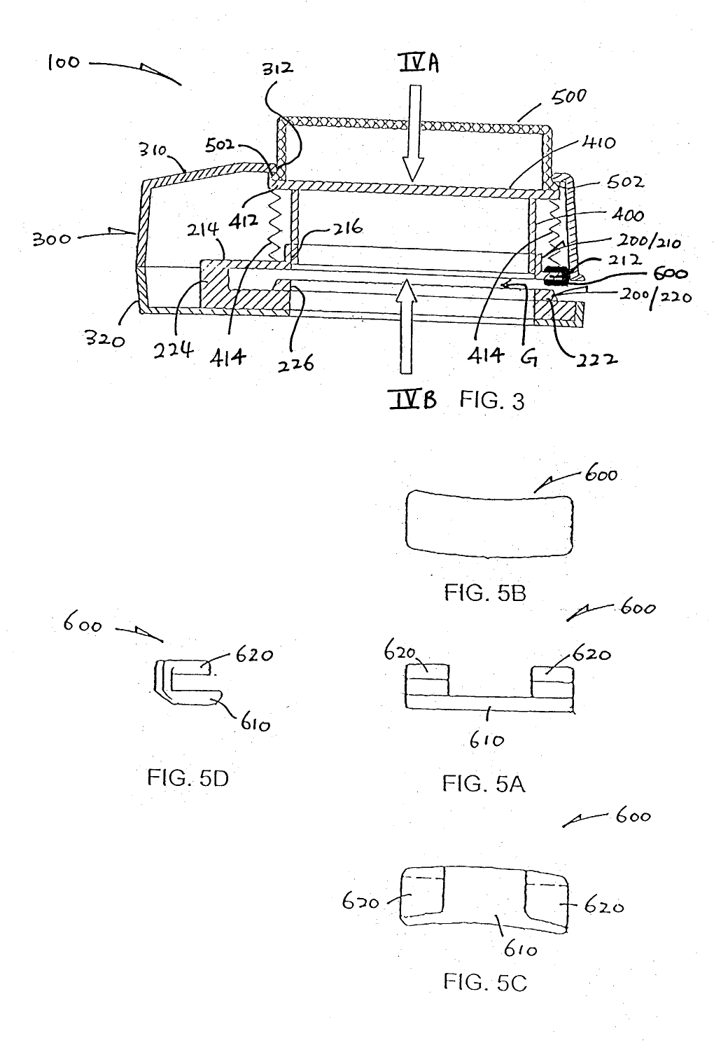

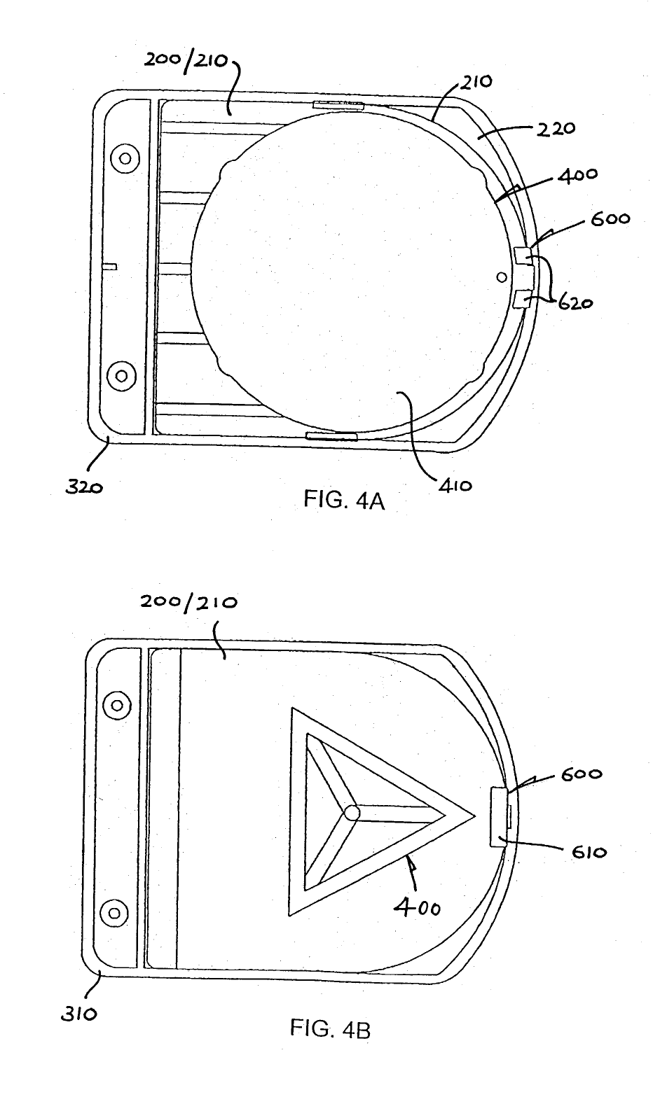

### DETAILED DESCRIPTION OF PREFERRED EMBODIMENT

The drawings show a punching device in the form of a jumbo sized paper punch 100 embodying the invention, which is designed for handicraft works for cutting a relatively large triangular hole in a sheet(s) of paper (or plastic) for example. The paper punch 100 comprises a die-cast metal body 200 of a sufficiently large size and a moulded plastic casing 300 enclosing the body 200. The body 200 consists of a pair of horizontal upper and lower parts 210 and 220 which are vertically spaced apart albeit integrally connected at their rear ends 214 and 224. A horizontal planar gap G is thus formed between the two body parts 210 and 220. The gap G has a uniform vertical width exceeding 2.0 mm, or 2.5 mm for example, into which a paper sheet to be punched may be inserted from between respective front ends 212 and 222 of the body parts 210 and 220.

The two body parts 210 and 220 are formed with respective apertures 216 and 226 of identical triangular shape and size and in perfect horizontal alignment with each other, which determine the hole to be punched in the paper sheet inserted into the gap G. Each side of the triangular apertures 216 and 226 measures about 60 mm in length.

During production, the gap G is formed by a rotary saw blade cutting through the body 200. The minimum thickness of the saw blade required for the relatively large size of the metal body 200 concerned is at least 2.0 mm, or 2.5 mm in the described embodiment, which dictates how narrow the gap G can be made in practice.

The casing 300 has an upper shell 310 and a lower shell 320 which enclose the upper and lower body parts 210 and 220 from above and below respectively, reaching just short of the open front and left and right sides of the gap G.

The paper punch 100 includes a die-cast metal punching die 400 which has a horizontal hollow cross-section of substantially identical triangular shape as the body apertures 216 and 226. The punching die 400 is inserted downwardly into the upper body aperture 216 and supported thereby for vertical sliding movement across the gap G into the lower body aperture 226 for performing a punching action.

The punching die 400 has an integral top plate 410 that is slightly enlarged to form a peripheral flange 412. Four compression coil springs 414 co-act between the flange 412 and the top side of the upper body part 210, thereby resiliently biassing the punching die 400 upwards just completely above the gap G. Thus, the punching die 400 is normally supported by the upper body part 210 alone. The springs 414 are arranged to provide the punching die 400 with a balanced biassing force, for example by being placed at equiangular positions around the die 400.

A plastic circular cap-like press knob 500 sits co-axially on top of the punching die 400, which protrudes upwardly out of the upper casing shell 310 through a circular aperture 312 thereof. Upon pressing, the press knob 500 pushes the punching die 400 downwards against the action of the springs 414 to perform a punching action. The press knob 500 includes a peripheral flange 502 for engaging behind the rim of the aperture 312.

The upper body part 210 is supported by the lower body part 220 in a cantilever manner about their rear ends 214 and 224. Thus, the upper body part 210 is inevitably vulnerable to being pivoted downwards about its rear end 214 relative to the lower body part 220, upon force pressing of the press knob 500 during a punching action. Over pivoting of the upper body part 210 is possible, as the gap G cannot in practice be made sufficiently narrow (limited by the minimum thickness of the saw blade forming the gap G) and normally only one or a few paper sheets are to be punched.

If the upper body part 210 is allowed to over pivot, its aperture 216 will move out of alignment from the lower body part aperture 226 to such an extent beyond tolerable allowance that the entry of the punching die 400 into the lower aperture 226 (for punching) will be jammed. To solve this problem, a small spacer 600 is provided at the front side of the gap G.

The spacer 600 consists of an oblong plastic plate 610 and a pair of left and right lugs 620 integral at opposite ends of the plate 610, overlying the plate 610 to form a flat C-shaped cross-section with the plate 610. The spacer 600 is located on (or adjacent in generally) the front end 212 of the upper body part 210 at a central position, riding laterally thereon like a clip embracing upper and lower sides of the front end 212. The front end 212 includes a central raised formation interlocked between the two lugs 620, whereby the spacer 600 cannot shift left or right. The spacer 600 is retained on the front end 212 by the bottom rim of the upper casing shell 310 (FIG. 3).

The spacer 600 is located such that its plate 610 underlies the front end 212 of the upper body part 210 and protrudes downwards into the gap G. The plate 610 has a thickness of 1.5 mm for example, that being a vertical dimension of at least half of the vertical width (2.5 mm) of the gap G, thereby reducing the effective width of the gap G to 1.0 mm. The plate 610 is positioned such that it is engageable with the upper surface of the lower body part 220, when the upper body part 210 is unavoidably pivoted downwards during a punching action. Upon abutment with the lower body part 220 (FIG. 2B), the plate 610 stops any further downwards pivoting of the upper body part 210, thereby limiting undesirable pivotal movement of the latter within allowable tolerance. Thus, the plate 610 serves to limit the undesirable downward movement of the upper body part 210 to within half of the gap width measured at the front ends 212 and 222 of the body parts 210 and 220. This ensures unobstructed entry of the punching die 400 into the lower aperture 226, and hence a smooth punching action.

It is envisaged that the spacer 600 may be provided on the lower body part 220 instead of the upper body part 210. In the broadest sense, the spacer of the subject invention is not limited to be at the front-end position as described, provided so long as that the spacer protrudes into or is at least in part situated in the gap G.

The invention has been given by way of example only, and various other modifications of and/or alterations to the described embodiment may be made by persons skilled in the art without departing from the scope of the invention as specified in the appended claims.

What is claimed is:

1. A punching device for punching a hole in a sheet of material, comprising a metal body having an upper part and a lower part each having a front end and a rear end and an aperture between the two ends, the apertures having substantially identical shape and size and being horizontally aligned with each other, the upper and lower body parts being interconnected at their rear ends and vertically spaced apart to form a horizontal planar gap therebetween into which a said sheet may be inserted for punching, and a punching die having a cross-section of a substantially identical shape and size as the apertures and supported within the upper aperture for downward movement across the gap into the lower aperture thereby punching a hole in a said sheet, wherein a spacer is located in the gap for limiting undesirable downward movement of the upper body part relative to the lower body part during a punching action.

2. The punching device as claimed in claim 1, wherein the spacer is located adjacent the front end of one of the upper and lower body parts, protruding into the gap for abutment with the other of the upper and lower body parts to limit said undesirable downward movement of the upper body part.

3. The punching device as claimed in claim 2, wherein the spacer is located at the front end of the upper body part, protruding downwards into the gap for abutment with the lower body part.

4. The punching device as claimed in claim 2, wherein the spacer has a C-shaped cross-section riding laterally on the front end of said one of the upper and lower body parts.

5. The punching device as claimed in claim 2, wherein the spacer comprises a clip embracing upper and lower sides of the front end of said one of the upper and lower body parts.

6. The punching device as claimed in claim 2, wherein the gap has a certain vertical width, and the spacer has a vertical dimension of at least half of the gap width to limit said undesirable downward movement of the upper body part to within half of the gap width measured at the front ends of the body parts.

7. The punching device as claimed in claim 1, wherein the gap has a substantially uniform vertical width exceeding 2.0 mm.

8. The punching device as claimed in claim 1, including a plurality of springs co-acting between the punching die and the upper body part to resiliently bias the punching die upwards, said springs being arranged to provide a balanced biassing force.

9. The punching device as claimed in claim 1, wherein the upper and lower body parts include and are enclosed by respective upper and lower plastic shells, said upper shell having a top aperture to enable depression of the punching die.
